(19) United States
(12) Patent Application Publication
(10) Pub. No.: US 2024/0086821 A1
(43) Pub. Date: Mar. 14, 2024

(54) DYNAMIC SUPPLY CHAIN DELIVERY OPTIONS USING COMPUTER SIMULATION

(71) Applicant: International Business Machines Corporation, Armonk, NY (US)

(72) Inventors: Christian Compton, Austin, TX (US); Todd Russell Whitman, Bethany, CT (US); Jeremy R. Fox, Georgetown, TX (US); Sarbajit K. Rakshit, Kolkata (IN)

(21) Appl. No.: 17/931,959

(22) Filed: Sep. 14, 2022

(51) Int. Cl. G06Q 10/08

(52) U.S. Cl. CPC G06Q 10/083

(57) ABSTRACT

A computer is used to generate dynamic supply chain delivery options for a product. Data is received at the computer, regarding a delivery of a product to a customer, the delivery is implemented using a delivery system. A change in a delivery time or location of the product is determined using the computer based on updated data received at the computer. A simulation is generated, using the computer, of simulated delivery plans based on the received data and the updated data. The simulated delivery plans are evaluated to determine an updated delivery plan based on parameters. The updated delivery plan is selected based on the parameters, and communicated to the delivery system.

### BACKGROUND

The present disclosure relates to using computer simulations for generating dynamic supply chain delivery options.

In one example, a customer receiving a delivery of a product can select a location for receiving an order including timing for receiving the order. In another example, the customer can define the order receiving location as a home, office, or temporary location. For example, the customer can share a real time location for a defined time range to the delivery system, and, if possible, the order delivery vehicle can arrive at the location and time to deliver the product to customer.

In another example of supply chain delivery, a customer can order products online from a seller, and the delivery system can identify an appropriate seller location and can deliver the product to the customer's location. The delivery system can identify an appropriate delivery vehicle, a mode of delivery, and can deliver the product to customer's location. While delivering the product(s) to a customer's location, the delivery system can perform various interaction(s) with the customer, for example, determine if the customer can pick the product up from a store, or pick up the shipment midway through the shipping on a delivery vehicle, or when the delivery system can manage delivering the product to a customer's home.

### SUMMARY

The present disclosure recognizes the shortcomings and problems associated with current techniques for generating digital modeling to determine alternative techniques for product delivery to a customer.

In one embodiment according to the present invention, a method or system can include a delivery system which predicts a change in delivery. A shopping system can dynamically engage with a customer's contextual location and communicate with the customer negotiate an additional amount of time to receive the product, or determine an alternate delivery location and time.

In another example, a method or system can include when a delivery system predicts a change in delivery, a shopping system dynamically engaging with the customer's contextual location and work with the customer to communicate an additional duration of time to receive the product, or determine an alternate delivery location and time.

I another example, a customer can define a dynamic location and timing for receiving a product. A delivery system can dispatch a delivery vehicle to reach the location to deliver the product. Circumstances may dictate where the product may be delayed, for example, problems with a vehicle, traffic, weather, etc. Depending on the severity of the delay, the customer may not be available at the location while delivering as initially planned. In this scenario, if the time window to deliver the product is small, the product can't be delivered on time and risks causing customer dissatisfaction.

In another embodiment according to the present disclosure, a method and system can include determining when a delivery system predicts a delay in delivery by a delivery vehicle. A system can communicate with the customer to remain in the location for an additional duration of time to receive the product or coordinate an alternate delivery location and time to maintain customer satisfaction.

In an aspect according to the present invention, a computer-implemented method for generating dynamic supply chain delivery options for a product, using computer simulations includes receiving data, at a computer, regarding a delivery of a product to a customer, and the delivery being implemented using a delivery system. The method includes determining, using the computer, a change in a delivery time or location of the product based on updated data received at the computer. The method includes generating a simulation, using the computer, of simulated delivery plans based on the received data and the updated data. The method includes evaluating the simulated delivery plans to determine an updated delivery plan based on parameters. The method includes selecting the updated delivery plan based on the parameters; and communicating the updated delivery plan to the delivery system, in response to the selecting of the updated delivery plan.

In a related aspect, the method further includes receiving the best delivery plane at a device of a delivery person or entity delivering the product as part of the delivery system.

In a related aspect, the change includes a delivery time change and/or a delivery location change.

In a related aspect, the change includes a delivery time change outside of a time range defined by the customer for delivery of the product.

In a related aspect, the best delivery plan includes notifying the customer by communicating with a customer device, a recommendation to remain at the location to receive delivery.

In a related aspect, the method can further include notifying the customer by communicating the best delivery plan with a customer device, wherein the best delivery plan includes a recommendation of an alternate delivery location.

In a related aspect, the delivery system includes a transportation vehicle, and a control center for administering the transportation vehicles.

In a related aspect, the change includes detecting a delay in delivery time and/or a change in delivery status.

In a related aspect, the updated data include information about acceptable delivery times from the customer and acceptable delivery locations from the customer.

In a related aspect, the simulation is a digital model.

In a related aspect, the method includes generating a digital model at least as part of the simulation, using the computer; and receiving a set of updated data regarding the delivery of the product to the customer; updating another change in a delivery time or the location of the product; updating the digital model based on the updated data; generating another updated delivery plan based on the digital model; and communicating the another updated delivery plan to the delivery system.

In a related aspect, the method can further include iteratively generating the digital model to produce updated models.

In another aspect according to the present invention, a system for generating dynamic supply chain delivery options using computer simulations includes a computer system comprising; a computer processor, a computer-readable storage medium, and program instructions stored on the computer-readable storage medium being executable by the processor, to cause the computer system to perform the following functions to; receive data, at a computer, regarding a delivery of a product to a customer, the delivery being implemented using a delivery system; determine, using the computer, a change in a delivery time or location of the product based on updated data received at the computer; generate a simulation, using the computer, of simulated delivery plans based on the received data and the updated data; evaluate the simulated delivery plans to determine an updated delivery plan based on parameters; select the updated delivery plan based on the parameters; and communicate the updated delivery plan to the delivery system, in response to the selecting of the updated delivery plan.

In a related aspect, the system further includes receiving the best delivery plane at a device of a delivery person or entity delivering the product as part of the delivery system.

In a related aspect, the change includes a delivery time change and/or a delivery location change.

In a related aspect, the change includes a delivery time change outside of a time range defined by the customer for delivery of the product.

In a related aspect, the best delivery plan includes notifying the customer by communicating with a customer device, a recommendation to remain at the location to receive delivery.

In a related aspect, the system further includes notifying the customer by communicating the best delivery plan with a customer device, wherein the best delivery plan includes a recommendation of an alternate delivery location.

In a related aspect, the delivery system includes a transportation vehicle, and a control center for administering the transportation vehicles.

In another aspect according to the present invention, a computer program product for generating dynamic supply chain delivery options using computer simulations includes the computer program product comprising a computer readable storage medium having program instructions embodied therewith. The program instructions are executable by a computer to cause the computer to perform functions, by the computer, comprising the functions to; receive data, at a computer, regarding a delivery of a product to a customer, the delivery being implemented using a delivery system; determine, using the computer, a change in a delivery time or location of the product based on updated data received at the computer; generate a simulation, using the computer, of simulated delivery plans based on the received data and the updated data; evaluate the simulated delivery plans to determine an updated delivery plan based on parameters; select the updated delivery plan based on the parameters; and communicate the updated delivery plan to the delivery system, in response to the selecting of the updated delivery plan.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating a system according to an embodiment of the present disclosure, for generating dynamic supply chain delivery options using computer simulations.

FIG. 2 is a flow chart of a method, according to an embodiment of the present disclosure, which can use the system depicted in FIG. 1, for generating dynamic supply chain delivery options using computer simulations.

FIG. 3 is a schematic block diagram of a system, according to another embodiment of the present disclosure, for generating dynamic supply chain delivery options using computer simulations.

FIG. 4 is a flow chart illustrating a method according to an embodiment of the present invention which can use the system depicted in FIG. 3, for generating dynamic supply chain delivery options using computer simulations.

FIG. 5 is a flow chart illustrating another method according to an embodiment of the present invention, continuing from the method shown in FIG. 4.

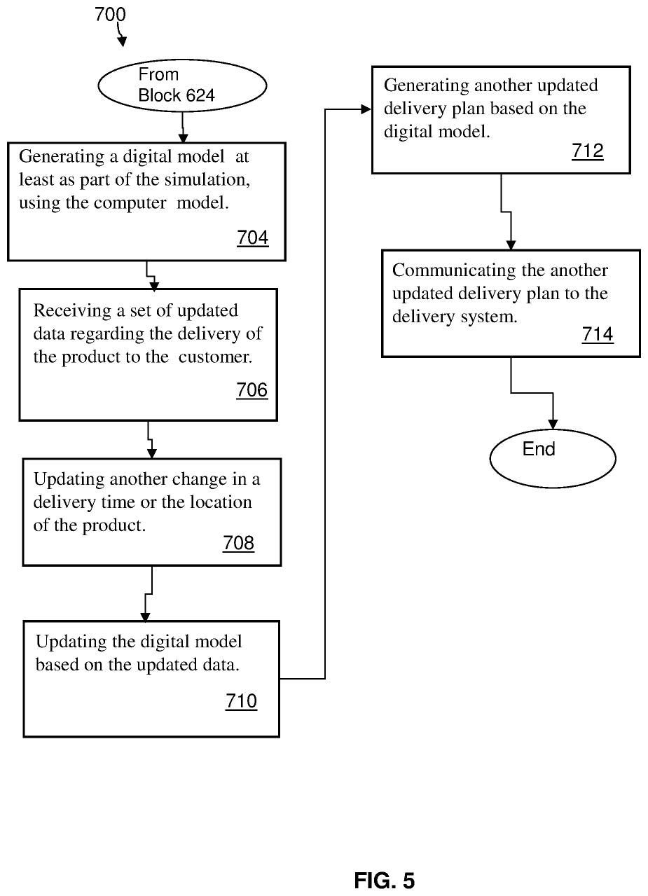

FIG. 6 is a schematic block diagram depicting a computer system according to an embodiment of the disclosure which may be incorporated, all or in part, in one or more computers or devices shown in other FIGS., and cooperates with the systems and methods shown in the FIGS.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### EMBODIMENTS AND EXAMPLES

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method.

It is understood that a customer can be an individual, or a group of individuals, or a company or an organization.

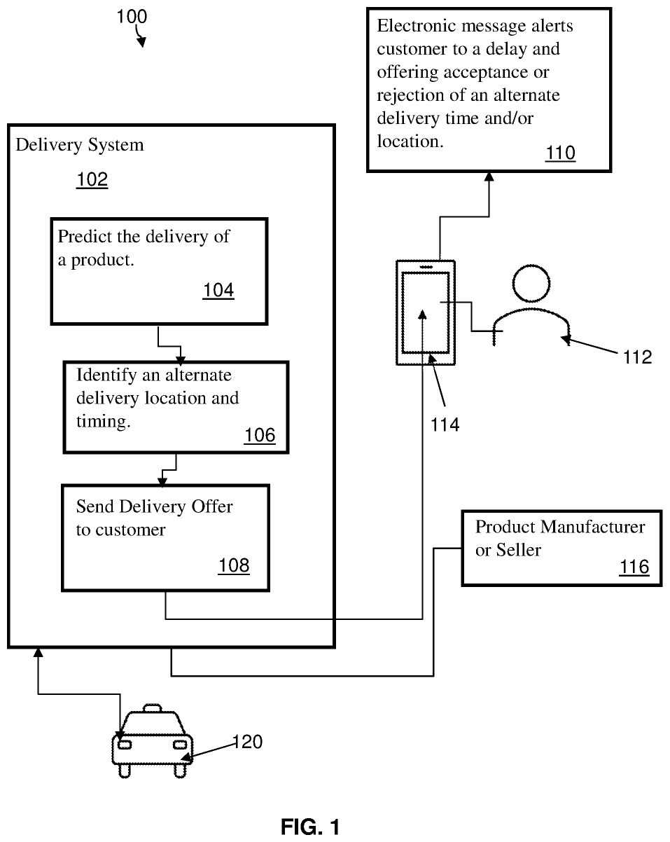

Referring to FIG. 1, according to an embodiment of the present disclosure, a system 100 for generating dynamic supply chain delivery options using computer simulations includes features described below. The delivery system 102 can communicate with a product manufacturer or seller 116. A delivery system 102 having a delivery vehicle 120 can predict a delay, as in block 104. While delivering a product to a customer, the delivery system can predict if the delivery vehicle can deliver the product within a defined time range and a defined location (e.g., park, shopping store, restaurant, train station, etc.) and accordingly based on a predicted amount of delay in product delivery, the proposed delivery system can identify alternate times and/or location of a delivery, as in block 106. Alternate times and locations can include recommending the customer to spend additional time at the current location and engage the customer with an offer (for example, a delivery vehicle can be delayed by a time (for example, 10 mins.), as in block 110. For 4example, the system can communicate with a device 114 of the customer 112. In one example, if the customer spends additional time, the customer can get a discount when ordering a future product. In another alternative, the system can identify an alternate delivery location and time.

In one example, a delivery vehicle can be late, and the system 102 can communicate a delivery offer to a customer, as in block 108, such as an offer for a discount to a customer. The system 102 can offer the discount based on identifying location-specific information about the customer to receive the order (e.g., park, shopping store, restaurant, train station etc.), if the delivery vehicle gets delayed, then the system can provide current location-specific offers to the customer. In one example, the customer can wait to receive the product by spending time at the current location. For example, if the customer is in a shopping complex, and the delivery gets delayed, then the proposed delivery vehicle can be notified that the customer is at the shopping complex, and the customer can be provided an offer on product present in the shopping complex.

In another example, the system can utilize a future customer location for delivery, e.g., a location where a customer is planning to arrive in the future. In one example, if the customer is not able to wait at the current location (e.g., the customer can be at a train station, and has to board the train at a specific time), then the system can receive information from the customer about the next available location and timing, and accordingly the delivery system can re-plan or update the product delivery to the customer, for example, an updated delivery plan.

In another example, a timely (such as a time window) delivery at a future user's location can include the system receiving an order, and the delivery system identifying if the customer has defined a time range to receive the order at a location. Accordingly, the delivery system can perform digital twin simulation of delivery plans to identify the feasibility of delivering a product within the time range. Accordingly, the system can plan the receiving of the order for processing and assigning an appropriate delivery vehicle for delivering the product to the customer.

In another example, the system can reroute a package delivery vehicle to a new location within a new delivery window. If the system determines that a product order is to be delivered to a different location and within a different time range (e.g., different location, as a customer is travelling), then the system will alter the delivery route, and/or vehicle, or warehouse so that the product(s) can be delivered to new location.

In another example, the system can include identifying a delivery vehicle for a planned delivery will be delayed. The system can identify alternate sellers/warehouses and accordingly alter delivery (e.g., using an updated delivery plan) so that a delay in the delivery can be avoided.

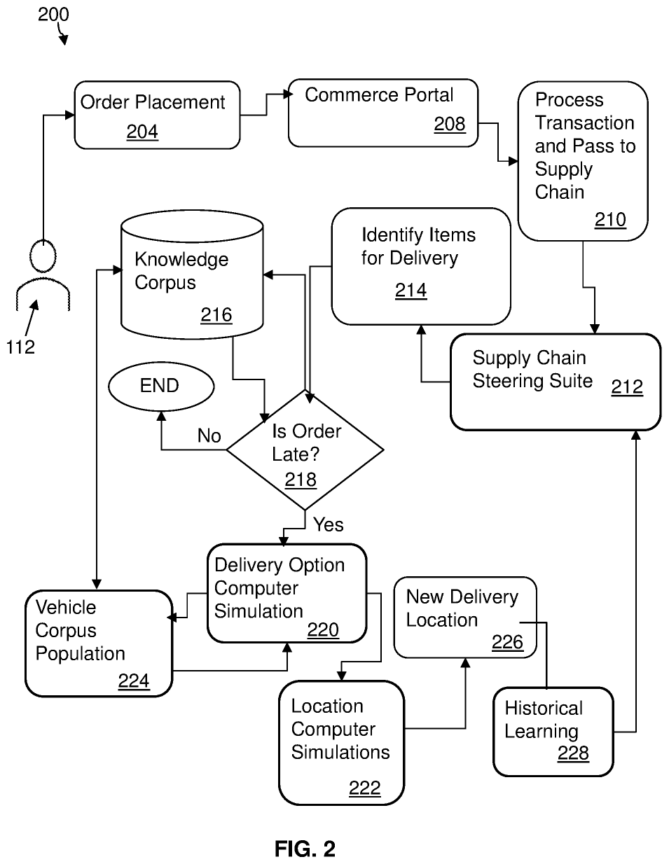

Referring to FIG. 2, with reference to the system 100 shown in FIG. 1, a method 200 according to an embodiment of the present disclosure includes a customer defining a delivery location and receiving a time window for delivery. When placing an order, the customer can define the receiving location and time range. The delivery system will process the time range and location of receiving, and simulate if a delivery is possible, using historical learning about traffic condition, delivery vehicle condition etc.

The method 200 includes a customer 112 placing an order as in block 204. The customer can place the order form a business, and/or using a computer application or an ordering computer service, or using a commerce portal as represented in block 208. The method includes processing a transaction which is initiated by the order placement, and passes the order or transaction to a supply chain, as in block 210. The supply chain can include a supply chain steering suite, as in block 212. The supply chain steering suite can include a control tower, supply chain applications, such as supplier collaboration, inventory management, and order management. The supply chain steering suite can also include supply chain insights and supply chain business network. The steering suite can also include a development hub which can include third party application, third party data, and third party networks.

The method 200 includes identifying item for delivery as in block 214. The method includes determining in block 218 if the order is late. If the order is not late, the method ends. If the order is late, the method continues to block 220. The method also shares the information of if the order is late with a knowledge corpus 216. Delivery options can be simulated, at block 220, using location computer simulation, as in block 222. The delivery option simulations can share information with a vehicle corpus population 224 which includes a vehicle population for use for deliveries. The vehicle corpus can share information with the knowledge corpus 216. A new delivery location 226 is an output of the location simulations and delivery option simulations. The new delivery location 226 can be shared with the supply chain steering suite 212.

The system and method can identify a sellers location and ability to fulfill a location of delivery and time window to make the delivery. The method 200 and system 100 can identify the appropriate warehouse and seller to deliver the product, so that the product can be delivered to the customer at the location, within a defined time range.

The method and system can include analyzing location specific information, and can identify if any location specific offer can be provided if the delivery timing is missed, for example at block 218. The method and system can determine if the delivery system predicts the delivery vehicle will not be able to reach a customer location within the defined time range, the system can estimate the amount of delay in delivering the product to the customer. The system can identify how long the customer needs to wait in the location. The delivery system can dynamically generate offers for the customer if the delivery gets delayed. The offer can be calculated based on the pricing of the product, duration of delay in delivery, location specific offer etc. An offer calculation rule can be defined by the delivery system, and once the offer is generated the offer can be sent to customer.

The method and system can include sending an offer containing the delay amount to a user device of a user. The user or customer can accept or reject the offer, for example, using a mobile phone, and accordingly the delivery system can be notified. If the customer accepts the offer, then the system can send the delivery vehicle and the product can be delivered. If the customer rejects an offer, for example of a new location and/or time for delivery, then the customer can define a new location and a time range and the information can be updated in the delivery system. The method and system can validate the new location and time or time range for receiving the order, and the system can validate the new location and/or time if the same route is selected or a different seller/warehouse will be selected or used. In one example, the method and system when identifying a planned delivery vehicle will be delayed, the system can identify an alternate seller/warehouse and accordingly an alternate delivery can be planned and completed.

In one example, various types of weather data can be utilized to determine that a time sensitive package might be running late within various parts of the supply chain due to weather. In another example, the method and system can use a fixed location locker for a time window and location. The location locker can be used when requirement parameters for a static location align with a customer's requirements, thus using a third-party locker. The method and system can ship a replacement product from a closer location, in response to a re-routing request or completion.

### OTHER EMBODIMENTS AND EXAMPLES

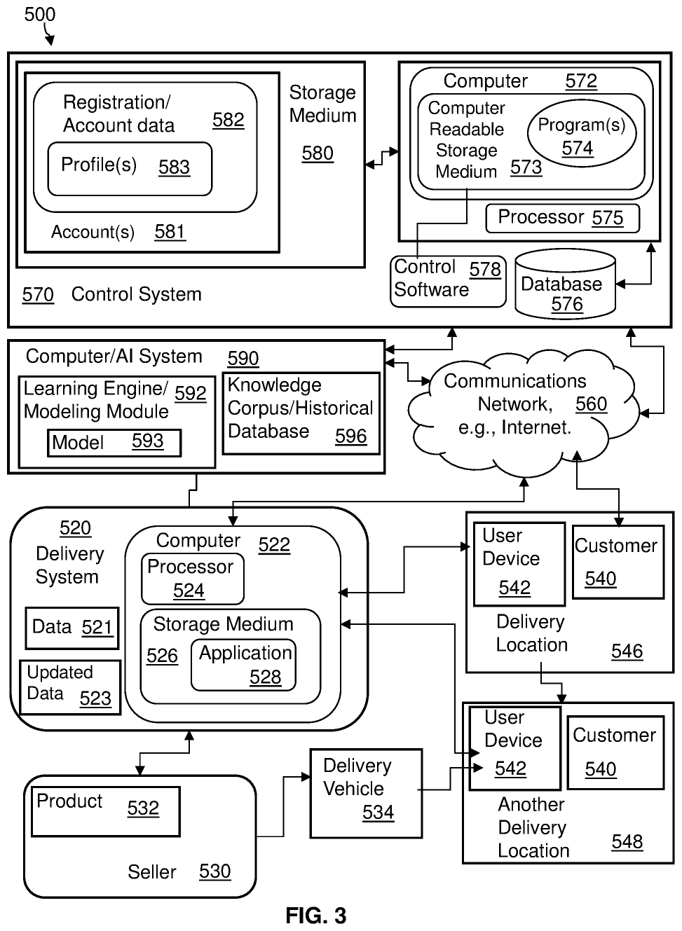

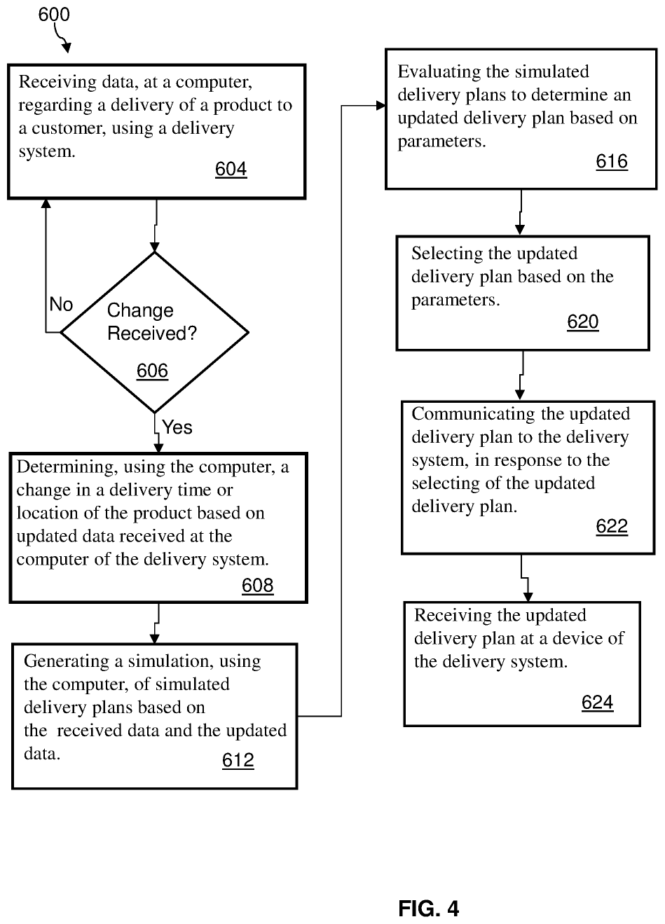

Referring to FIG. 4, in an embodiment according to the present disclosure, a computer-implemented method 600, using a system 500 shown in FIG. 3, can generate dynamic supply chain delivery options using computer simulations. The method 600 includes receiving data 521, at a computer 522, regarding a delivery of a product 532 to a customer 540 at a location 546, as in block 604. The delivery can be implemented using a delivery system 520, also as in block 604. For example, the delivery can be implemented using a delivery vehicle 534, such as a motor vehicle, or a drone, and can be managed using the delivery system 520 or a control center such as a control system 570.

In one example, the delivery system 520 can include a computer 522 including a processor 524 and a computer readable storage medium 526 where an application 528 can be stored or embedded which can in one example, embody all or part of the method of the present disclosure. The application can include all or part of instructions to implement the method of the present disclosure, embodied in code and stored on a computer readable storage medium. The computer and/or device can include a display. The computer 522 can operate, in all or in part, in conjunction with a remote server by way of a communications network 560, for example, the Internet. The application can include instructions to communicate with other computer system applications via a network, for example the Internet.

The method includes determining when a change is received at block 606. When a change is not received, the method returns to block 604. When a change is received, the method 600 proceeds to block 608.

The method 600 includes determining, using the computer, a change in a delivery time or location of the product based on updated data 523 received at the computer 522 of the delivery system 520, as in block 608. The change, for example, can include a time delay, a change in delivery location, a change in warehouses, a change in a delivery time period, a change in a pick-up mode, a change in customer, for instance when product delivery is canceled.

The method 600 includes generating a simulation, using the computer, of simulated delivery plans based on the received data 521 and the updated data 523, as in block 612. The simulation can be generated using the computer at the delivery system, or alternatively using a computer 590 communicating with the delivery system using a network 560. The computer 590 can includes a learning engine 592 and one or models 593, and further a knowledge corpus 596 of historical data, for example, data relating the customer, the product, delivery locations, warehouses and information regarding the warehouses, and logistical information. In one example, the simulation is generated using input data such as the received data, an output includes a delivery plan, and as updated data is received and inputted, an updated output is generated which includes an updated delivery plan.

The method 600 includes evaluating the simulated delivery plans to determine an updated delivery plan based on parameters, as in block 616.

The method 600 includes selecting the updated delivery plan based on the parameters, as in block 620. The method further includes communicating the updated delivery plan to the delivery system, in response to the selecting of the updated delivery plan, as in block 622. The updated delivery plan can include another delivery location 548 for delivering the product or package to the customer. The method includes receiving the updated delivery plan at a device of the delivery system, as in block 624, for updating delivery services, such as communicating the updated delivery services to a device of an operator of a vehicle for delivering the product to the customer.

The method according to the present disclosure can include receiving the best delivery plane at a device of a delivery person or entity delivering the product as part of the delivery system. The change according to the method can include a delivery time change and/or a delivery location change. Further, the change can include a delivery time change outside of a time range defined by the customer for delivery of the product. In another example, the best delivery plan includes notifying the customer by communicating with a customer device, a recommendation to remain at the location to receive delivery.

The method can include notifying the customer by communicating the best delivery plan with a customer device, and the best delivery plan includes a recommendation of an alternate delivery location. The delivery system can include a transportation vehicle, and a control center for administering the transportation vehicles. The change can include detecting a delay in delivery time and/or a change in delivery status. The updated data can include information about acceptable delivery times from the customer and acceptable delivery locations from the customer. In one example, the simulation can include, at least in part, a digital model.

In another embodiment according to the present disclosure, a method 700 continues from block 624 of the method 600 shown in FIG. 4, and the method 700 includes generating a digital model at least as part of the simulation, using the computer, as shown in block 704. The method 700 includes receiving a set of updated data regarding the delivery of the product to the customer, as in block 706. The method includes updating another change in a delivery time or the location of the product, as in block 708. The method includes updating the digital model based on the updated data, as in block 710. The method includes generating another updated delivery plan based on the digital model, as in block 712. The method includes communicating the another updated delivery plan to the delivery system, as in block 714. The method can further include iteratively generating the digital model to produce updated models.

### ADDITIONAL EXAMPLES AND EMBODIMENTS

In one example, referring to the figures, for example in FIG. 3, a system 500 includes a computer 522 which can be integral to or communicating with a device, and communicate with other computers such as a hand held device of a customer or user. A computer 590 remote from the delivery system 520 can electronically communicate, in all or in part, with a control system computer 572 as part of a control system 570. The control system can include the computer 572 having a computer readable storage medium 573 which can store one or more programs 574, and a processor 575 for executing program instructions, and can also include control software 538 for managing the one or more programs. The control system can also include a storage medium which can include registration and/or account data 582 and profiles 583 of users or entities (such entities can include robotic entities) as part of user accounts 581. User accounts 581 can be stored on a storage medium 580 which is part of the control system 570. The user accounts 581 can include registrations and account data 582 and user profiles 583. The control system can also include the computer 572 having a computer readable storage medium 573 which can store programs or code embedded on the storage medium. The program code can be executed by a processor 575. The computer 572 can communicate with a database 576. The control system 570 can also include a database 576 for storing all or part of such data as described above, and other data.

The control system can also communicate with a computer system 590 which can include a learning engine/module 592 and a knowledge corpus or database 596. The computer system 590 can also communicate with a computer of a device and can be remote from a user device. In another example, a computer system can be all or part of a control system. The depiction of a computer system as well as the other components of the system are shown as one example according to the present disclosure. One or more computer systems can communicate with a communications network 560, e.g., the Internet. For example, a computer and the control system can communicate with the communications network 560, and a device/computer can communicate with a local communications network which can communicate with the communications network 560.

In one example, a new or different AI (Artificial Intelligence) ecosystem, or technology/communication or IT (Information Technology) ecosystem can include a local communications network which can communicate with the communications network 560. The method can include an analysis generating a model 593 based on received data. A model can also be generated by an AI system, at least in part. In one example, an AI system can generate a model using an AI system analysis using machine learning.

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Thus, in one example, a control system can be in communication with a computer or device, and the computer can include an application or software. The computer, or a computer in a mobile device can communicate with the control system using the communications network. In another example, the control system can have a front-end computer belonging to one or more users, and a back-end computer embodied as the control system.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

A control system can include a storage medium for maintaining a registration of users and their devices for analysis of the audio input. Such registration can include user profiles, which can include user data supplied by the users in reference to registering and setting-up an account. In an embodiment, the method and system which incorporates the present disclosure includes the control system (generally referred to as the back-end) in combination and cooperation with a front end of the method and system, which can be the application. In one example, the application is stored on a device, for example, a computer or device on location, and can access data and additional programs at a back end of the application, e.g., control system.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, which may be shown, for example, in the example figures, for instance an application stored on a computer readable storage medium of a computer or device. The application is stored on the device or computer and can access data and additional programs at the back end of the application, for example, in the program(s) stored in the control system.

The program(s) can include, all or in part, a series of executable steps for implementing the method of the present disclosure. A program, incorporating the present method, can be all or in part stored in the computer readable storage medium on the control system or, in all or in part, on a computer or device. It is envisioned that the control system can not only store the profile of users, but in one embodiment, can interact with a website for viewing on a display of a device such as a mobile device, or in another example the Internet, and receive user input related to the method and system of the present disclosure. It is understood that embodiments shown in the figures depicts one or more profiles, however, the method can include multiple profiles, users, registrations, etc. It is envisioned that a plurality of users or a group of users can register and provide profiles using the control system for use according to the method and system of the present disclosure.

In one example, received data can include data in a knowledge corpus and historical database, which can be populated by historical data gathered, for example, from sensors, robotic device, or other machines or devices.

Referring to one or more embodiments in the figures, a computer or a device, also can be referred to as a user device or an administrator's device, includes a computer having a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet.

It is understood that the user device is representative of similar devices which can be for other users, as representative of such devices, which can include, mobile devices, smart devices, laptop computers etc. A user and a related account can refer to, for example, a person, or an entity, or a corporate entity, or a corporate department, or another machine such as an entity for automation such as a system using, in all or in part, artificial intelligence.

Additionally, methods and systems according to embodiments of the present disclosure can be discussed in relation to a functional system(s) depicted by functional block diagrams. The methods and systems can include components and operations for embodiments according to the present disclosure, and is used herein for reference when describing the operational steps of the methods and systems of the present disclosure. Additionally, the functional system, according to an embodiment of the present disclosure, depicts functional operations indicative of the embodiments discussed herein.

### MORE EXAMPLES AND EMBODIMENTS

The methods and systems of the present disclosure can include a series of operational blocks for implementing one or more embodiments according to the present disclosure. A method shown in the figures may be another example embodiment, which can include aspects/operations shown in another figure and discussed previously, but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

### FURTHER DISCUSSION REGARDING EXAMPLES AND EMBODIMENTS

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants. It is also understood that machine and device are used interchangeable herein to refer to machine or devices in one or ecosystems or environments, which can include, for example and artificial intelligence (AI) environment.

### STILL FURTHER EMBODIMENTS AND EXAMPLES

A computer implemented method as disclosed herein can include modeling, using the computer. The model can be generated using a learning engine or modeling module of a computer system which can be all or in part of an Artificial Intelligence (AI) system which communicates with the computer and/or a control system. Such a computer system can include or communicate with a knowledge corpus or historical database. In one example, an acceptable model can include a model meeting specified parameters. In another example, an acceptable model can be a model which has undergone several iterations of modeling. When the model is not acceptable, the method can return to return to a previous operation or proceed as directed, for example as represented by a operational block in a flowchart.

In one example according to the present disclosure, a method can generate a model, using a computer, which can include a series of operations. The model can be generated using a learning engine or modeling module of a computer system which can be all or in part of an Artificial Intelligence (AI) system which communicates with a computer and/or a control system. Such a computer system can include or communicate with a knowledge corpus or historical database.

The model can be generated using a learning engine or modeling module of a computer system which can be all or in part of an Artificial Intelligence (AI) system which communicates with a computer and/or a control system. Such a computer system can include or communicate with a knowledge corpus or historical database. A model can also be generated by an AI system such as an output at least in part of an AI system analysis using machine learning.

### ADDITIONAL EMBODIMENTS AND EXAMPLES

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### OTHER ADDITIONAL EMBODIMENTS AND EXAMPLES

In one example, Artificial Intelligence (AI) can be used, all or in part, for generating a model or a learning model as discussed herein in embodiments of the present disclosure. An Artificial Intelligence (AI) System can include machines, computer, and computer programs which are designed to be intelligent or mirror intelligence. Such systems can include computers executing algorithms. AI can include machine learning and deep learning. For example, deep learning can include neural networks. An AI system can be cloud based, that is, using a cloud-based computing environment having computing resources. In another example, a control system can be all or part of an Artificial Intelligence (AI) system. For example, the control system can be one or more components of an AI system.

It is also understood that methods and systems according to embodiments of the present disclosure, can be incorporated into (Artificial Intelligence) AI devices, components or be part of an AI system, which can communicate with respective AI systems and components, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### MORE ADDITIONAL EXAMPLES AND EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

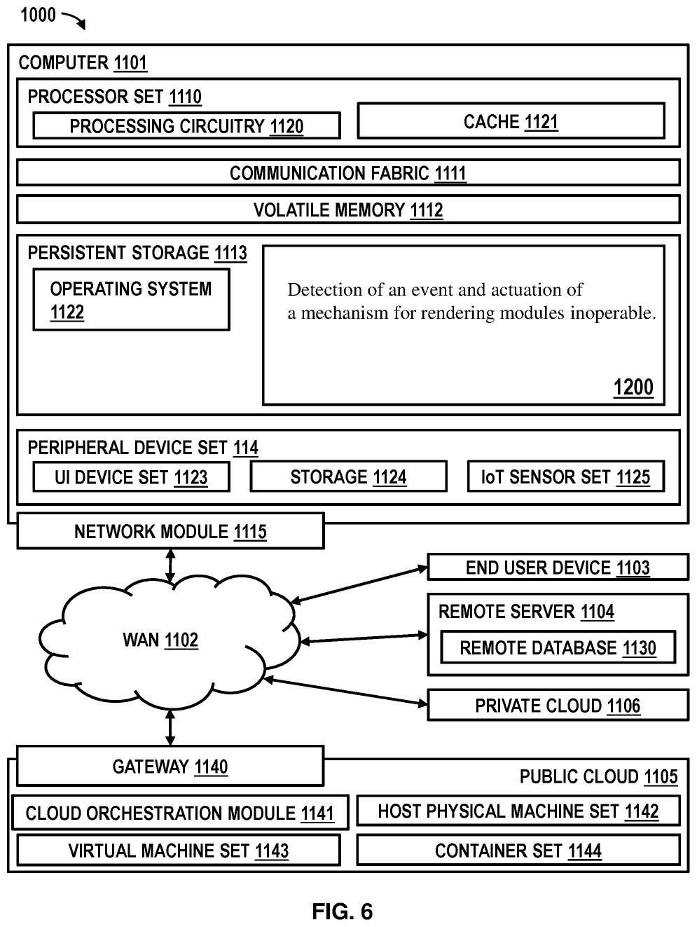

Referring to FIG. 6, a computing environment 1000 contains an example of an environment for the execution of at least some of the computer code involved in performing the inventive methods, such as detection of an event, such as a breach of the pressurized housing, and actuation of a device or mechanism for rendering modules inoperable, such as damaging memory modules to render them inoperable 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

It is also understood that the one or more computers or computer systems shown in the figures can include all or part of other computing environments, such as computing environment 1000, and its components shown in the figures. In one example, the one or more computers can communicate with all or part of a computing environment and its components as a remote computer system, to achieve the computer functions described in the present disclosure.

What is claimed is:

1. A computer-implemented method for generating dynamic supply chain delivery options for a product, using computer simulations, comprising:
receiving data, at a computer, regarding a delivery of a product to a customer, the delivery being implemented using a delivery system;
determining, using the computer, a change in a delivery time or location of the product based on updated data received at the computer;
generating a simulation, using the computer, of simulated delivery plans based on the received data and the updated data;
evaluating the simulated delivery plans to determine an updated delivery plan based on parameters;
selecting the updated delivery plan based on the parameters; and
communicating the updated delivery plan to the delivery system, in response to the selecting of the updated delivery plan.

2. The method of claim 1, further comprising:
receiving the best delivery plane at a device of a delivery person or entity delivering the product as part of the delivery system.

3. The method of claim 1, wherein the change includes a delivery time change and/or a delivery location change.

4. The method of claim 1, wherein the change includes a delivery time change outside of a time range defined by the customer for delivery of the product.

5. The method of claim 1, wherein the best delivery plan includes notifying the customer by communicating with a customer device, a recommendation to remain at the location to receive delivery.

6. The method of claim 1, further comprising:
notifying the customer by communicating the best delivery plan with a customer device, wherein the best delivery plan includes a recommendation of an alternate delivery location.

7. The method of claim 1, wherein the delivery system includes a transportation vehicle, and a control center for administering the transportation vehicles.

8. The method of claim 1, wherein the change includes detecting a delay in delivery time and/or a change in delivery status.

9. The method of claim 1, wherein the updated data include information about acceptable delivery times from the customer and acceptable delivery locations from the customer.

10. The method of claim 1, wherein the simulation is a digital model.

11. The method of claim 1, further comprising:
generating a digital model at least as part of the simulation, using the computer;
receiving a set of updated data regarding the delivery of the product to the customer;
updating another change in a delivery time or the location of the product;
updating the digital model based on the updated data;
generating another updated delivery plan based on the digital model; and
communicating the another updated delivery plan to the delivery system.

12. The method of claim 11, further comprising:
iteratively generating the digital model to produce updated models.

13. A system for generating dynamic supply chain delivery options using computer simulations, which comprises:
a computer system comprising; a computer processor, a computer-readable storage medium, and program instructions stored on the computer-readable storage medium being executable by the processor, to cause the computer system to perform the following functions to;
receive data, at a computer, regarding a delivery of a product to a customer, the delivery being implemented using a delivery system;
determine, using the computer, a change in a delivery time or location of the product based on updated data received at the computer;
generate a simulation, using the computer, of simulated delivery plans based on the received data and the updated data;
evaluate the simulated delivery plans to determine an updated delivery plan based on parameters;
select the updated delivery plan based on the parameters; and
communicate the updated delivery plan to the delivery system, in response to the selecting of the updated delivery plan.

14. The system of claim 13, further comprising:
receiving the best delivery plane at a device of a delivery person or entity delivering the product as part of the delivery system.

15. The system of claim 13, wherein the change includes a delivery time change and/or a delivery location change.

16. The system of claim 13, wherein the change includes a delivery time change outside of a time range defined by the customer for delivery of the product.

17. The system of claim 13, wherein the best delivery plan includes notifying the customer by communicating with a customer device, a recommendation to remain at the location to receive delivery.

18. The system of claim 13, further comprising:
notifying the customer by communicating the best delivery plan with a customer device, wherein the best delivery plan includes a recommendation of an alternate delivery location.

19. The system of claim 13, wherein the delivery system includes a transportation vehicle, and a control center for administering the transportation vehicles.

20. A computer program product for generating dynamic supply chain delivery options using computer simulations, the computer program product comprising a computer readable storage medium having program instructions embodied therewith, the program instructions executable by a computer to cause the computer to perform functions, by the computer, comprising the functions to:
receive data, at a computer, regarding a delivery of a product to a customer, the delivery being implemented using a delivery system;
determine, using the computer, a change in a delivery time or location of the product based on updated data received at the computer;
generate a simulation, using the computer, of simulated delivery plans based on the received data and the updated data;
evaluate the simulated delivery plans to determine an updated delivery plan based on parameters;
select the updated delivery plan based on the parameters; and
communicate the updated delivery plan to the delivery system, in response to the selecting of the updated delivery plan.
